(19) United States
(12) Patent Application Publication
(10) Pub. No.: US 2005/0060164 A1
(43) Pub. Date: Mar. 17, 2005

(54) Delivery system and method

(76) Inventor: BRIAN ELI BERL ILLION, TORONTO (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/660,524

(22) Filed: Sep. 12, 2003

(51) Int. Cl. G06F 17/60

(52) U.S. Cl. 705/1

(57) ABSTRACT

A delivery system and method for delivering one of a plurality of identical products from a seller to a purchaser. The identical products are transported in a delivery circuit around a plurality of delivery nodes. It is then determined if one of the identical products has been ordered by one of the purchasers. If so, then it is determined which of the plurality of delivery nodes is closest to the purchaser. Then, the closest one of the identical products is provided to that delivery node along the delivery circuit and then the product is transported from the delivery node to the purchaser. The method also includes the association of each of the identical products with a unique tracking number. Also, the destination address of said purchaser is determined and the unique tracking number and destination address is “pushed” to the delivery closest to the purchaser node prior to the physical arrival of the products at the delivery node.

### FIELD OF THE INVENTION

This invention relates generally to delivery systems and methods and more particularly to an improved system and method for product delivery.

### BACKGROUND OF THE INVENTION

Typically, sellers of products either ship a certain amount of product to retail outlets for on-site purchase by customers. The disadvantage of shipping products to retail outlets for on-site purchase is that prospective purchasers must physically attend at the retail outlets to purchase said product. Also, when the product is over-sold, there is often a substantial re-stocking delay before the product is available again for purchase, causing potential purchasers to put off or abandon plans to order a product from a seller. To avoid stock outages, seller's carry excess inventory tying up capital, and often requiring mark downs at the end of the selling season in order to liquidate excess stock.

Alternatively, sellers wait until an order is received from purchaser before shipping a product directly to purchaser. Both of these methods of product delivery suffer from substantial disadvantages. The disadvantages associated with shipping a product to a purchaser after an order has been received include the expense of using high-speed delivery mechanisms (e.g. air freight) to provide the purchaser with the product in a timely fashion. If it is not desired to incur the substantial costs associated with high-speed delivery then there typically is a substantial delivery period. Either the high cost or the substantial delivery period can discourage purchasers from purchasing products from seller.

Substantial resources are spent each year to improve delivery time by creating faster and faster modes of transportation and warehousing and order-picking technology. Conventional delivery systems typically achieve “time-to-customer” improvements by increasing the speed of shipping or increased expediting (i.e. order picking or processing speed). Also, conventional distribution systems require repeated physical labeling by various parties (e.g. the manufacturer, the distributors, etc.).

### SUMMARY OF THE INVENTION

The invention provides in one aspect, a method of delivering one of a plurality of identical products associated with a seller to a purchaser, said method comprising:
(a) transporting the identical products in a delivery circuit that includes a plurality of delivery nodes by transporting the identical products between delivery nodes at a first speed;
(b) determining if one of said identical products has been ordered by one of the purchasers;
(c) if (b) is true then determining which of said plurality of delivery nodes is closest to said purchaser;
(d) providing the closest one of said identical products to the delivery node identified in (c) along the delivery circuit and then transporting said closest one of said identical products from the delivery node identified in (c) to said purchaser.

In another aspect, the invention provides a delivery system for delivering a plurality of identical products associated with a seller to a plurality of purchasers, said system comprising:
(a) a first delivery module for transporting the identical products in a delivery circuit that includes a plurality of delivery nodes at a first speed;
(b) a distribution module associated with said first delivery module for determining if one of the products has been ordered by said one of the purchasers, and if so then determining which of said plurality of delivery nodes is closest to said one of the purchasers; and
(c) a second delivery module associated with said distribution module for providing the closest of said identical products to said identified delivery node through said delivery circuit and then from said identified delivery node to said one of the purchasers.

Further aspects and advantages of the invention will appear from the following description taken together with the accompanying drawings.

### BRIEF DESCRIPTION OF THE DRAWINGS

In the accompanying drawings:

FIG. 1 is block diagram illustrating the operation of the delivery system of the present invention;

FIG. 2 is a flowchart illustrating the general operational steps of the delivery system of FIG. 1;

FIG. 3 is a block diagram of the delivery system of FIG. 1 illustrating the exchange of information between seller, distributor and the distribution nodes of the circulation circuit of FIG. 1;

FIG. 4A is a schematic representation of the seller's record maintained within the seller database of FIG. 3;

FIG. 4B is a schematic representation of the distributor's record maintained with the distributors database of FIG. 3;

FIG. 5A is a flowchart illustrating the process steps of the CIRCULATION routine conducted by the delivery system of FIG. 1;

FIG. 5B is a flowchart illustrating the process steps of the SOLD routine conducted by the delivery system of FIG. 1;

FIG. 6 is a block diagram illustrating how the delivery system of FIG. 1 manages the flow of products within delivery circuit 25; and

FIG. 7 is a flowchart illustrating how product demand is forecasted and how product rebalancing is achieved within the delivery system of FIG. 1.

### DETAILED DESCRIPTION OF THE INVENTION

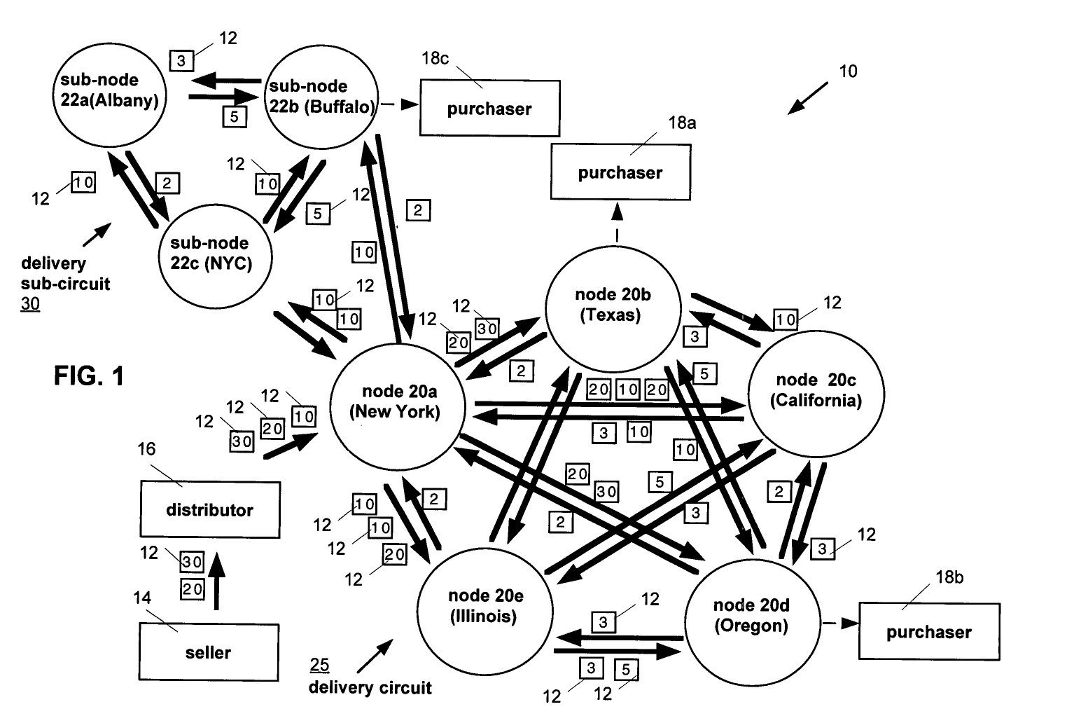

Reference is first made to FIG. 1, which shows a block diagram of the delivery system 10 made in accordance with a preferred embodiment of the present invention. Delivery system 10 achieves time-efficient delivery of products 12 from a seller 14 through a distributor 16 to a purchaser 18 through the transportation of products 12 within a delivery circuit 25 that includes a plurality of delivery nodes 20a to 20e and a delivery sub-circuit 30 that includes a plurality of delivery sub-nodes 22a to 22c. The nodes in each of the delivery circuit 25 and sub-circuit 30 are interconnected through a web of transportation links as shown in FIG. 1. Products 12 are transported within a delivery circuit 25 that covers a general geographical area based on estimates of product demand for product 11 within that geographical area, such that at the time of an order by purchaser 18, the required number of products 12 can be efficiently transported from the closest delivery node 20a to 20e within delivery circuit 25 to a closest delivery node 22a to 22c within sub-circuit 30 for direct delivery to purchaser 18.

Purchaser 18 is physically located within the geographical area covered by delivery nodes 20a to 20e and can either represent a retail store (e.g. SEARS, WALMART, etc.) or an end purchaser/consumer (e.g. a mail or Internet order customer). Delivery system 10 provides a retail store purchaser 18 with quick stock replenishment without expensive delivery mode (e.g. air freight, local warehousing). Also, delivery system 10 provides an end consumer purchaser 18 with quick delivery.

Seller 14 is a conventional wholesale, retail or mail order sales entity (e.g. TOYS R US, SONY, etc.) of products 12 who initially owns products 12 and seeks to sell products 12 to retail or end consumer purchasers 18. Delivery system 10 is particularly suited to sellers 14 who sell a substantial number of identical (i.e. interchangeable) products 12 to a plurality of purchasers 18 throughout the delivery circuit 25. Seller 14 wishes to have sufficient products 12 available within delivery circuit 25 so that product 12 can be re-directed to retail or end-consumer purchasers 18 within a predetermined period of time from the time of order (e.g. 24 hours). In the case of retail store purchasers 18, this means providing stock replenishment for example within a 24-hour period to ensure that retail store purchaser 18 can maintain a minimal level of stock in-store (i.e. stock depth), while minimizing the risk of being completely out of stock of that particular product.

Distributor 16 can either be a conventional distributor (e.g. UPS, FEDEX, etc.) of products 12 or a logistics and supply chain management entity who coordinates and provides transportation of products 12 between seller 14 and purchaser 18 using delivery system 10. Distributor 16 utilizes the dynamic nature of delivery system 10 (i.e. which allows products 12 to be re-rerouted in transit as will be described) to ensure efficient delivery of product 12 from seller 14 to purchaser 18. It should be understood that distributor 16 could also be the same entity as the seller 14.

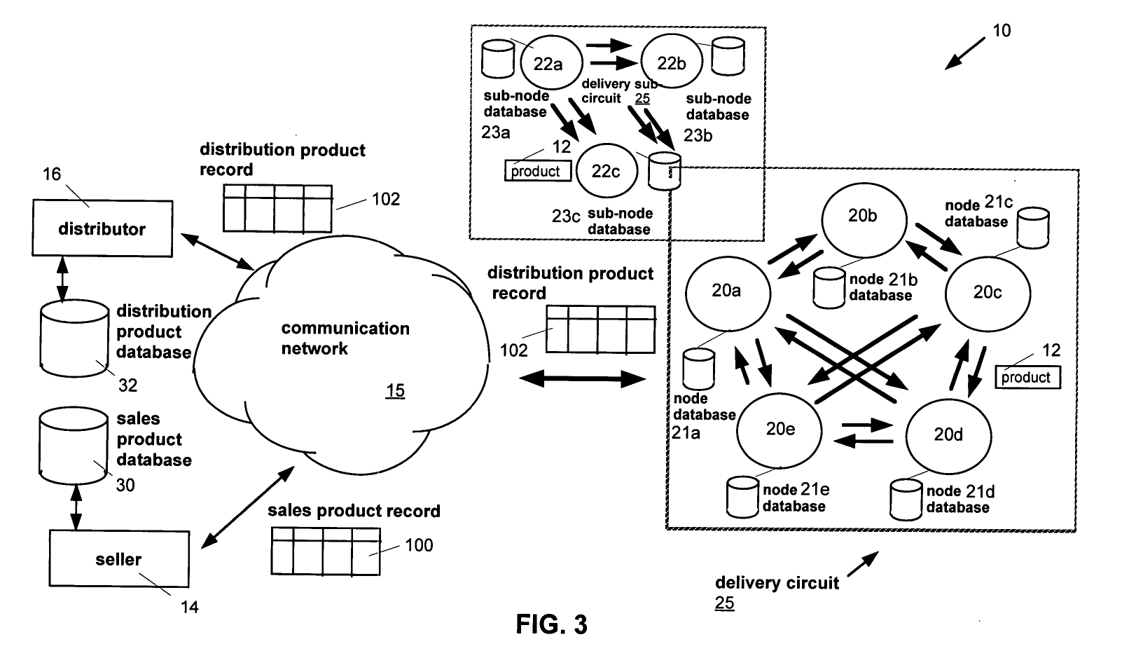

Delivery nodes 20a to 20e and sub-nodes 22a to 22c are sorting stations that provide conventional package sorting functions and limited warehousing. Products 12 are sorted using electronic or manual means at delivery nodes 20a to 20e and sub-nodes 22a to 22c. A unique Universal Tracking Number (UTN) is assigned to each product 12 and the distribution product (which will be described) record associated with each such UTN within a product container is used to identify the specific routing information associated with that product 12 (or products 12 within a package of product 12) which is then in turn used to route product 12 within delivery system 10. A backbone computer network (e.g. connected via. the Internet as will be described in relation to FIG. 3) allows delivery nodes 20a to 20e and sub-nodes 22a to 22c to exchange product related record information with distributor 16.

Distribution product record data as will be described is either ‘pushed’ or ‘pulled’ to local on-site sorting node databases to pre-load relevant routing information into the local sorting node database in advance of product 12 reaching the sorting node at issue. More specifically, the UTN record data associated with all of the products 12 within a product container is pushed to the node database before the container of products 12 reaches the node. Using this approach, it is possible to quickly ascertained the contents and routing requirements associated with the contents of a container and accordingly minimize the typical delay associated with retrieving container/product related information from an off-site database. Also, it is possible to facilitate high speed package sorting without the risk of data “under run” errors. Delivery nodes 20a to 20e and sub-nodes 22a to 22c also include a small warehousing area as well as loading bays, conveyor belts, sorting bins/areas that interface with various transportation modes (e.g. rail, truck, air etc.) as is conventionally known. Conventionally, computerized package sorting systems conduct high speed package sorting based on associated zip codes. However, delivery system 10 requires modification of such conventional sorting equipment to allow for package sorting based on the reading or scanning of the UTN record are looking up the destination or routing information from the distribution product record.

Delivery nodes 20a to 20e are configured to form a delivery circuit 25 with a web of transportation links connecting each of the nodes as shown in FIG. 1. It should be understood that the specific number and configuration of delivery nodes 20a to 20e depicted in FIG. 1 have been chosen for illustrative purposes and that many different configurations are possible. The delivery nodes 20a to 20e in this example span a wide geographical area (e.g. from New York to Texas, to California and back through Oregon, and Michigan). It is preferred for slow and cost effective transport to be utilized along the delivery circuit 25 (e.g. freight train etc.) It should be understood that while a simple delivery circuit 25 is provided in FIG. 1 for illustrative purposes, many different delivery circuits could be utilized by a particular seller 14 within delivery circuit 25. For example in the case where a seller 14 has only “released” a product in the New York state region of the U.S., a particular delivery circuit could be delineated to encompass delivery nodes 20a and delivery sub-nodes 22a to 22c only.

Delivery sub-nodes 22a to 22c are configured to form a delivery sub-circuit 30 as shown. It should be understood that the specific number and confirmation of number sub-nodes 22a to 22c depicted in FIG. 1 have again been chosen for illustrative purposes and that many different specific configurations are possible. As shown, the number sub-circuit 30 spans a smaller region than that spanned by number nodes 20a to 20e and specifically in the New York state region (e.g. from New York City, to Buffalo to Albany).

Product 12 can enter delivery system 10 at any one of various points along delivery circuit 25. For example, when a seller 14 and distributor 16 are located within the geographical region of delivery circuit 25 (i.e. in this case within the U.S.), products 12 can either all be forwarded by distributor 16 directly to one node (e.g. node 20a New York) or they can be forwarded by distributor 16 to a number of nodes simultaneously (e.g. to node 20a New York, node 20c California and node 20d Oregon). As the products 12 move from node to sub-node it should be understood that they are sorted and possibly redistributed into different shipping containers as needed for proper transport to the next node or sub-node. For example, when products 12 reach node 20a (i.e. New York) they are sorted by the next level of geographic or routing detail (e.g. New York City, Albany, Buffalo). The New York City products 12 are consolidated along with other packages into appropriate shipping containers and freighted to the New York City sub-node 22c and the Buffalo products 12 are consolidated into separate shipping containers and sent to the Buffalo sub-node 22b and so on.

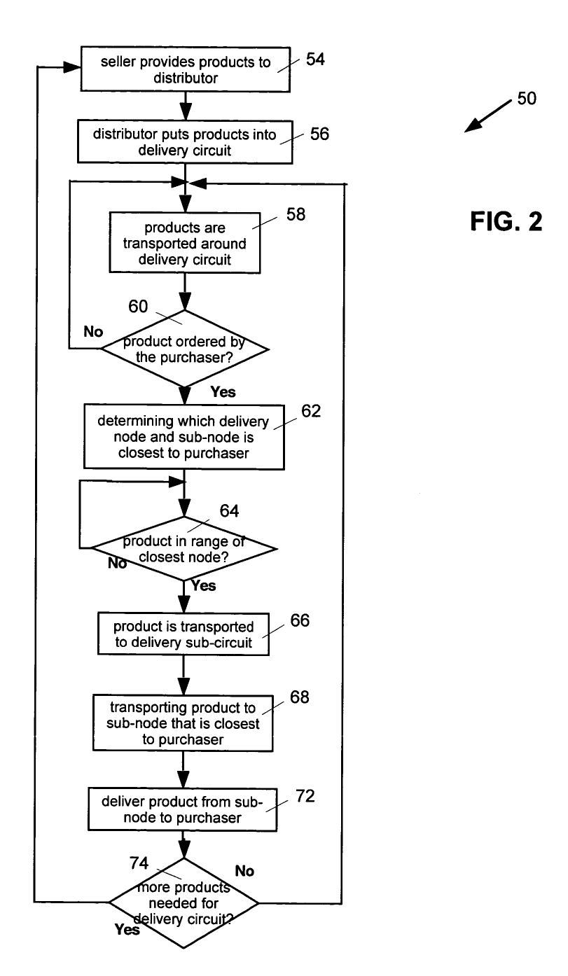

Referring now to FIGS. 1 and 2, the general operational steps 50 of delivery system 10 are illustrated. At step (54), products 12 are provided by seller 14 to distributor 16 for circulation within delivery circuit 25. At step (56), distributor 16 puts products 12 into delivery circuit 25. At step (58), products 12 are transported within delivery circuit 25. More specifically, products 12 are distributed from an entry point to the various nodes in an efficient and direct manner avoiding as much as possible the need to pass through intermediate nodes in order to reach the destination node. At step (60), it is determined whether product 12 has been ordered by purchaser 18. If not, then at step (58) product 12 continues to be transported within delivery circuit 25. If so, then at step (62), distributor 16 determines which delivery node 20a to 20 within delivery circuit 25 is closest to purchaser. For the purposes of this example, it should be assumed that purchaser 18c has ordered product 12. Accordingly, distributor 16 will determine that delivery node 20a in New York state is closest (of all delivery nodes within circulation circuit 25).

At step (64), the various UTN codes are searched to determine the product 12 that is closest to the delivery node identified in step (62) along circulation circuit 25. Once the closest product 12 is identified (by UTN code) (e.g. if product 12 is at delivery node 20a in New York state), at step (66), the final shipping address is inserted into the distribution record for that product 12 (as will be described) and product 12 is transported to delivery sub-circuit 30. At step (68), distributor 16 determines which delivery sub-node is closest to purchaser and transports product 12 to that sub-node. In this example, the closest sub-node would be delivery sub-node 22b in Buffalo, N.Y. At step (70), it is determined whether product 12 is at the closest delivery sub-node. Finally at step (72), product 12 is delivered from delivery sub-node 22b to purchaser 18.

At step (74), estimated and actual demand for product is assessed and then it is determined whether additional products 12 are required to be transported within delivery circuit 25. Generally, purchaser demand for product 12 is periodically estimated within delivery system 10 and is expressed in terms of a ‘par’ product velocity (e.g. 12 units per day) for a particular node (e.g. delivery sub-node 22c). If additional products 12 are required, then at step (76), additional products are shipped. If not, then at step (54), seller 14 provides additional products 12 to distributor 16 for delivery using delivery system 10. If so, then at step (58), the existing volume of products 12 are simply further transported around delivery circuit 25. The preferred product demand estimation methodology utilized within delivery system 10 is based on the principle that product sold should be replaced. That is, if product is sold from a delivery sub-node (e.g. New York City sub-node 22c), then the ‘parent’ node (e.g. New York delivery node 20a) should deploy replacement product 12 to that delivery sub-node and seller 14 should add replacement product 12 to delivery system 10 to replenish the product concentration at that delivery node 20a.

It should be understood that for the clarity of illustration, the specific delivery method shown in FIG. 2 assumes that the product delivery circuit 25 only consists of delivery nodes (i.e. not sub-nodes). However, it should be understood that the delivery circuit 25 could also contain delivery sub-nodes as well.

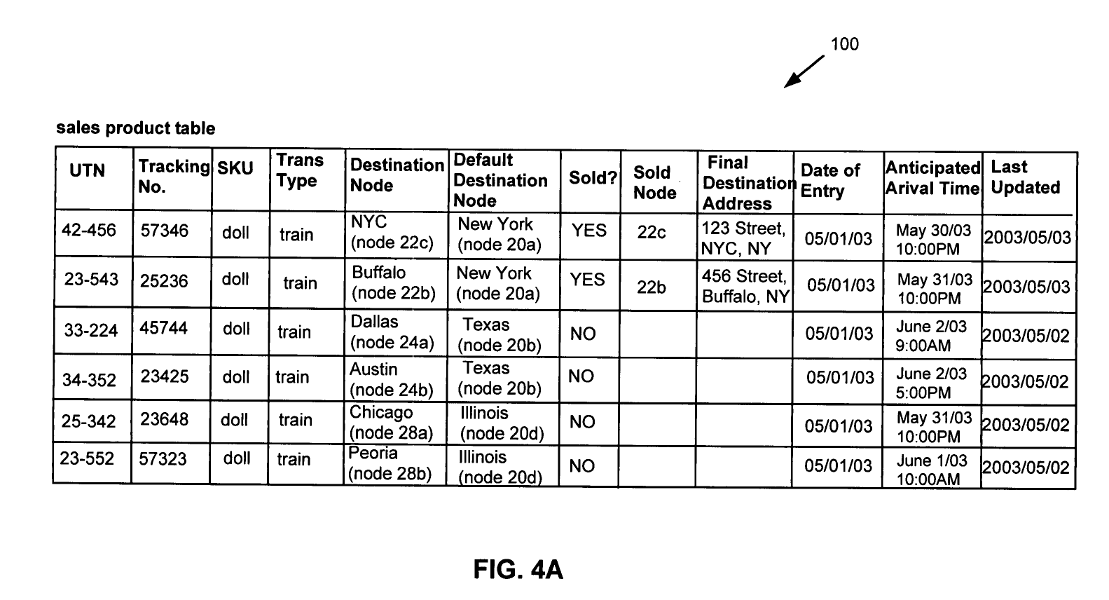

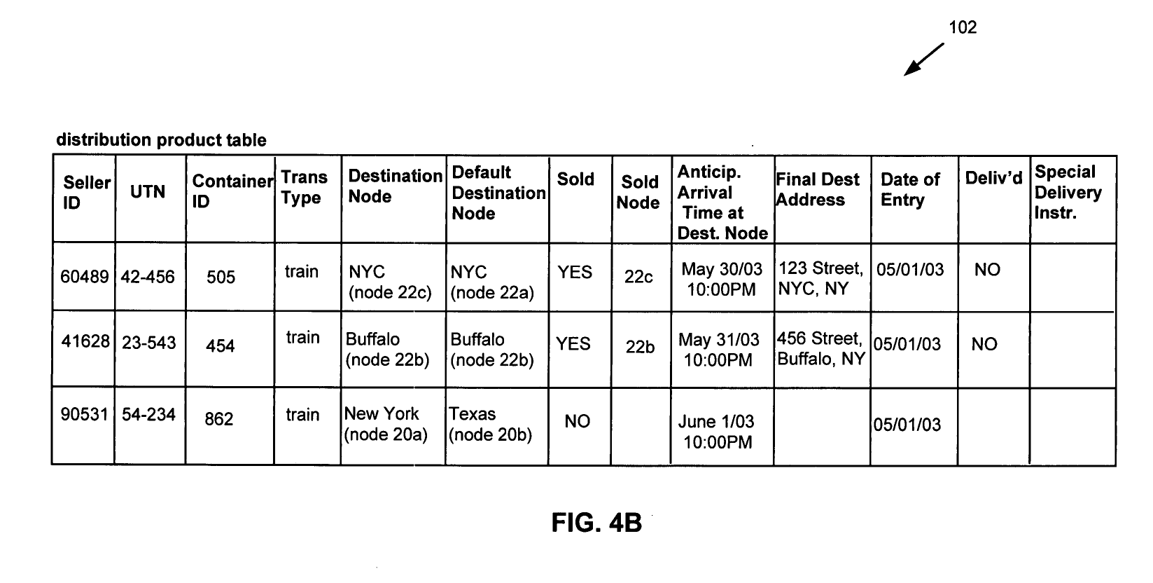

Referring now to FIGS. 1, 2, 3, 4A and 4B the exchange of delivery and product related information between seller, distributor and the delivery nodes 20a to 20e and delivery sub-nodes 22a to 22c of FIG. 1 during the delivery of product 12 from seller 16 to purchaser 18 will be described. Specifically, FIG. 3 is a block diagram of the delivery system of FIG. 1 illustrating in more detail and FIGS. 4A and 4B illustrate an example sales product table 100 which contains sales product records (SPR) and a sample distribution product table 102 which contains distribution product records (DPR). Again, it should be understood that the specific configuration of delivery nodes 20a to 20e and delivery sub-nodes 22a to 22c have been arbitrarily chosen for illustrative purposes and that many other configurations of delivery nodes and sub-nodes may be utilized within delivery system 10. It should be understood that the Unique Tracking Number (UTN) is a critical index field that is common amongst all of the databases shown in FIG. 3.

As shown in FIG. 3, seller 14 maintains a sales product database 30 containing sales product table 100 (FIG. 4A). Initially, seller 14 provides distributor 16 with products 12 for circulation within delivery circuit 25. Seller 14 compiles sales product table 100 (FIG. 4A) for products 12, containing records that each have, a Unique Tracking Number (UTN), a company-specific or internal Tracking Number (could be a company serial number for the product), a Stock Keeping Unit (SKU) identifier (e.g. “doll”), a Transportation Type, a Destination Node, a Default Destination Node, a Sold Indicator (i.e. boolean value YES or NO), a Sold Node (when Sold=YES), Final Destination Address, Date of Entry, Anticipated Arrival Time (at Destination Node), and a Last Updated fields. Seller 14 electronically forwards certain records from sales product table 100 to distributor 16 over communication network 15 (e.g. over the Internet) as shown. Records within sales product table 100 are maintained and updated periodically as distributor 16 coordinates the movement of products 12 recorded in these records. The sales information associated with sales product table 100 is used for internal marketing and sales efforts as well as for forecasting purposes as will be further described.

As previously discussed, each product 12 is assigned a Universal Tracking Number (UTN) as well as an internal Tracking No. Also, the SKU is populated with the type of product at issue (e.g. “doll”). The Transportation Type is set to be the most appropriate type of transport (e.g. “Train”, “Truck”, etc.) for the trip to the associated Destination Node. The Destination Node is the next node at which product 12 will arrive and be sorted at. It should be understood that Destination Node is defined as being the next node at which products 12 may be rerouted. However, the Destination Node may not be the closest node in terms of physical proximity. For example, a product 12 in transit from the New York City sub-node 22c to the Buffalo sub-node 22b (and therefore the Destination Node would be set as 22b) may actually be physically closer to sub-node 22a Albany. However, in order to reroute the product it would be necessary for it to first arrive in the Buffalo sub-node 22b.

A Default Destination Node is also provided for each product 12 so that delivery system 10 does not stall if the product 12 reaches the Destination Node before being sold. In this way, product 12 is always routed in a “look-ahead” fashion wherein the Destination Node is the next sorting node at which product 12 will arrive and the Default Destination Node is “one-step” ahead (i.e. the next destination should product 12 not be rerouted or sent directly to a purchaser). It should be noted that the Default Destination Node field is always populated whether or not a product 12 has been sold. It is the node to which product 12 will be sent upon arrival at the Destination Node in the absence of a sale or redirection. If the product 12 is not sold or rerouted, then the existing Default Destination Node will be entered as the Destination Node and a new node will be chosen as the Default Destination Node according to system estimates of geographical product demand and rebalancing as will be discussed.

When product 12 is sold, the Final Destination Node field is populated and the Sold Indicator is set to “YES”. Also, the delivery node at which product 12 has been sold is indicated in the Sold Node Field is recorded for replenishment calculation and forecasting purposes as will be described. The date at which product 12 entered delivery circuit 25 is also stored within the Date of Entry field. This is used to determine the optimal product 12 to send to a purchaser 18 in the case where two products 12 are equally close to a particular delivery node 20 (i.e. to prevent the existence of “stale” or “delivery worn” products 12 or to maximize stock rotation (i.e. following the well-known FIFO convention)).

The Anticipated Arrival Time field contains fixed date and time information as to when the package is expected to arrive at the Destination Node. (e.g. May 30, 2003 10:00 PM). Thus, this is an estimate which is based on such things as mode of transportation, expected conditions, the distance to the Destination Node and the specific Destination Node. It is important to have fixed date information so that seller 14 knows ‘by when’ a particular product 12 needs to be rerouted, as it cannot be rerouted at the Destination Node unless the routing information in the appropriate record of the distribution product table 102 is updated prior to the arrival of the physical product and the associated distribution product record information at the Destination Node Thus, the Anticipated Arrival Time At Node gives an estimate as to by when new instructions must be issued in order to effect the rerouting of product 12.

It should be noted however, that it would be desirable to not only enter the instructions by the Anticipated Arrival time but by a given amount of time prior to that. There are several reasons for this. For example, as stated above the Anticipated Arrival time is only and estimate and as such may not be entirely accurate. Product 12 may arrive early and therefore be sorted and sent to the next Node earlier than anticipated. Furthermore, there is a finite amount of time between the entering of the instructions within the system and the time at which this information has percolated to all relevant areas within the system. Thus, it is possible that the instructions are entered prior to the arrival of the package at the Node but not early enough for the information to have been received and implemented by appropriately rerouting the package at the relevant node. Clearly this could create serious difficulties in which instructions are set and expected to be implemented but in fact are not.

Thus, in order to avoid any such difficulties, a blackout period may be instituted for a given time period just prior to the Anticipated Arrival Time. During this period changes will not be allowed to the records. The duration of such a period could be function of the standard deviation of the error associated with the Anticipated Arrival Time. For example, if the error in estimating the Anticipated Arrival Time is the dominant factor, setting a black out period of a given multiple of the error would approximately ensure a given percentage accuracy that the issued instructions would in fact have sufficient time to be implemented.

Finally, the Last Updated field is used to determine when the product record has been last updated and will flag any “inactive” or potentially lost products 12 within delivery system 10.

Similarly, distributor 16 maintains a distribution product database 32 that contains distribution product table 102 (FIG. 4B). Upon receiving sales product table 100 and associated products 12, distributor 16 utilizes certain records and information from sales product table 100 and certain defaults to populate the fields of its own internal distribution product table 102. Specifically, each record within distribution product table 102 consists of a Seller ID (i.e. to track various client sellers 18), a Universal Tracking Number (UTN), Container ID, Transportation Type, Destination Node, Default Destination Node, Sold Indicator, Sold Node, Anticipated Arrival Time (at Destination Node), Final Destination Address, Date of Entry, Delivered Indicator, and Special Delivery Instructions. Many of these fields have been detailed above and it should be understood that they have the same significance within distribution product table 102.

The Seller ID is a unique identifier that is used to track the associated Seller for each product 12. The Container ID is used to track and identify the various UTN-indexed products 12 packaged within a truckload container or other shipping container. Accordingly, when a container of products 12 arrives at a delivery node identification can be accomplished relatively quickly. For example, the product records associated with container ID 505 can be quickly identified through an index search using “505” in the container ID field to provide information on which products are in the container and their routing information. The Container No., along with the associated UTN codes and the Default Destination Nodes (i.e. destination delivery nodes) are used to filter and “push” the appropriate distribution product table 102 to the relevant destination delivery nodes. The container ID field is updated after each sort, and it is contemplated that the container ID field can incorporate or be associated with information as to the location of origin of that container (i.e. the place where the last sort occurred). Furthermore, the anticipated arrival time of the container at its destination can also be used for purposes of scheduling the ‘pushing’ or ‘pulling’ of the appropriate distribution product table 102 to the destination nodes.

The Sold field is a boolean value which indicates whether the associated product 12 has been sold. If the product 12 has been sold then the Final Destination Address is populated and the Delivered field is populated with “NO”. When the product 12 is delivered to purchaser 18 then the Delivered field is changed to “YES” and the record is removed from the distribution product table 102.

Once products 12 are sent by seller 14 through distributor 16 towards delivery circuit 25, the various record fields are routinely updated as product 12 approaches delivery circuit 25 and as product 12 traverses delivery circuit 25. Seller 14 updates its records first and then pushes this information down to down to distributor's 16 records. That is, the various record fields within the system databases contain a digital “image” mapping of the delivery circuit 25 such that the location of each product 12 is known within the delivery circuit 25. This allows a particular product 12 to be re-rerouted or sent to a final destination based on accurate information regarding when a particular product 12 is scheduled to reach the next sorting node.

Specifically, as shown in FIG. 4B, the first two products 12 received from seller 14 (i.e. dolls with UTN 42-456 and 23-543) have been sold to purchasers within New York State and a third one (UTN 54-234) that has not yet been sold. A Default Destination Node is provided for each product 12 so that delivery system 10 does not stall if said product reaches the Destination Node prior to being sold. Accordingly, it should be noted that the Default Destination field is always populated whether or not a product 12 has been sold. It is the node to which product 12 will be sent upon arrival at the Destination Node, should it not be rerouted or sent directly to a purchaser. Thus, should the product 12 not be sold or rerouted the node listed in the Default Destination Node field will be entered in the Destination Node field and a new node will be chosen as the Default Destination node. Of course, should it be desired that upon arrival, product 12 be rerouted to a different node, the Destination Node may be updated accordingly and need not become what is currently entered in the Default Destination Node field. The Default Destination Node field is updated every time a new Destination Node is set.

For illustrative purposes, it should be assumed that these three products 12 have reached distribution node 20a (i.e. New York State). Thus, the first product 12 (i.e. with UTN=42456) has one day until arrival at the location of the first purchaser 18 (i.e. the New York City sub-node 22c) and two days until arrival at the location of the second purchaser 18 (i.e. the Buffalo city sub-node 22b) as indicated by the geographical placement of the delivery nodes shown in FIG. 1. The corresponding Anticipated Arrival Times are provided in the distribution product table 102 as shown. Finally, the third product 12 has not been sold and accordingly the Anticipated Arrival Time field shows the time at which the product is expected to arrive at the next Destination Node.

When the third product 12 reaches delivery node 20b and if it has not yet been sold (i.e. sold field=“NO”), then the Destination Node will be equated to the Default Destination Node (i.e. node Texas 20b and Default Destination Node will be assigned a new valve (e.g. “California Node 20c”)), so that it continues to traverse delivery circuit 25 as shown in FIG. 1. Accordingly, the default setting can be arbitrary (e.g. such that product 12 traverses along a ‘dumb’ delivery circuit). Alternatively, it can be set and updated such that product 12 is directed to delivery nodes 20a to 20e and sub-nodes 22a to 22c which need replenishment due to sales or based on statistical demand analysis for the type of product 12 being shipped at particular delivery nodes 20a to 20e nodes and sub-nodes 22a to 22c. The setting and updating of the Default Destination field for each product 12 is preferably modeled on a “par” flow rate required in each zone. For example, it could be determined that the zone associated with sub-node 22a needs at least five units of product 12 cycling through it per day, and that the zone associated with node 22e needs ten units of product 12 cycling through it per day. The Default Destination within each distribution product record could be set accordingly.

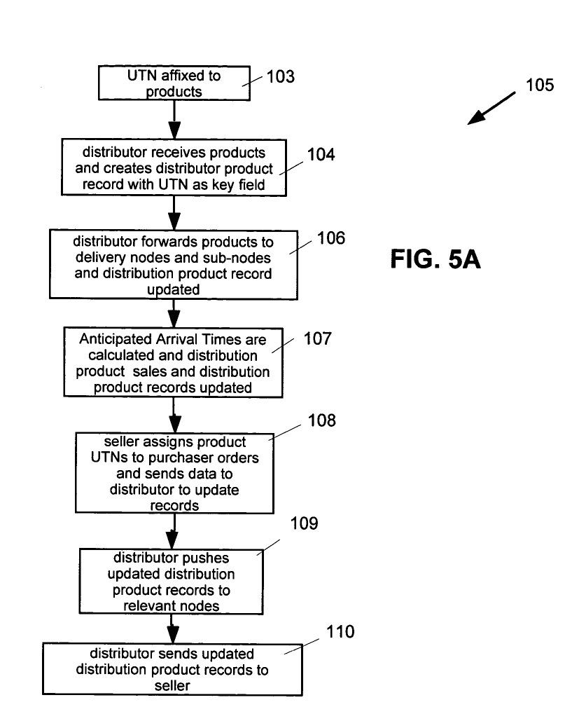

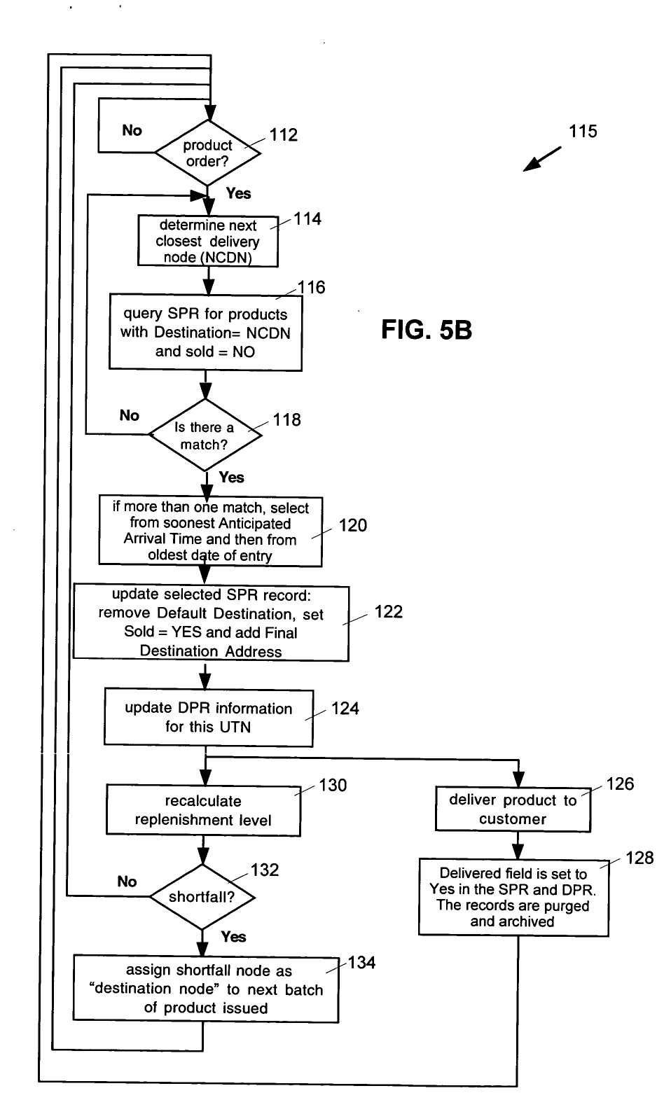

Referring to FIGS. 3, 4A, 4B, 5A and 5B, the dynamic nature of Sales product table 100 and distribution product table 102 and their use within delivery system 10 will be specifically illustrated. Specifically, FIG. 5A is a flowchart illustrating the process steps of the CIRCULATION routine 105 conducted by the delivery system 10 of FIG. 1.

At step (103), a Universal Tracking Number (UTN) is affixed to product 12. Preferably, the UTN is affixed at or prior to the time of product shipment by seller 14. It should be understood that it is contemplated that seller 14 could place a bar code containing a UTN at the time of manufacture and that this UTN code number would be used by any distributor 18 (i.e. shipping company) to obtain routing information over communication network 15. That is, in analogy to the conventional numbering scheme utilized by cheques (i.e. with a unique identifier for both the financial institution and customer), it is contemplated that the UTN would consist of a company code (i.e. assigned to a specific company and not assigned to any other company) followed by a serial number that represents the particular product 12. In this way, no two products 12 in the system 10 will have the identical UTN code. This would also allow, for example, products 12 being shipped from China, to be routed and distributed while on the ship. Upon landing at the dock, the cargo can be immediately provided to delivery system 10 and delivered using the UTN for routing purposes. This approach reduces the amount of manual handling of the goods for labeling, consolidating, order-picking etc. It should also be understood that the UTN code itself does not have to be in any particular form as long as it is utilized as a common index between seller 14 and distributor 16.

Accordingly, when distributor 16 receives products 12 from seller 14, a Universal Tracking Number (UTN) has already been associated with each product 12. Then at step (104), distributor 16 creates an associated distribution product table 102 with the UTN as the key (i.e. index) field and stores this record in distribution database 32. It should also be understood that products 12 according to the meaning of the present invention, can either represent individual products in the conventional sense (i.e. individual dolls) or larger collection of products (e.g. boxes containing a plurality of products such as a box of three soap bars). As discussed above, containers of products 12 can be themselves identified by the Container ID within the distribution product table 102. At step (106), distributor 16 physically sends products 12 (typically using cost effective surface type transport such as rail freight transport) to relevant delivery nodes 20a to 20e and to delivery sub-nodes 22a to 22c within delivery circuit 25 based on calculated Default Destination Node information provided by seller 14. Also, at step (106), the distribution product table 102 is updated.

At step (107), the Anticipated Arrival Time at the Destination Node is calculated and placed in Anticipated Arrival Time field in the distribution product table 102. The Destination Node field of the sales product table 100 is also updated so that seller 14 can determine the deadline for updating the Default Destination Node field in the distribution product table 102. It should be understood that this step has to be completed before the distribution product table 102 is pushed to the applicable delivery node. At step (108), seller 14 assigns products 12 by their UTN codes to purchaser orders that come in based on the location of the product 12 (i.e. as revealed by a lookup of the UTN code within the distribution product table 102 and the distribution product table 102 is updated with these changes in sellers 14 data. Also, it should be understood that seller 14 sends sales data associated with the applicable UTN codes to distributor 16 for incorporation into distribution product table 102 prior to scheduled data push to node.

At step (110), distributor 16 pushes the updated distribution product table 102 to the relevant delivery nodes for storage within node databases 21a to 21e and sub-node databases 23a to 23c. This is accomplished prior to the arrival of the container bearing the applicable products 12 so that all records associated with products 12 located in the container can be loaded into the automatic barcode sorter software within the applicable node databases prior to physical arrival of products 12.

Now referring to FIG. 5B, FIG. 5B illustrates the process steps of the SOLD routine 115 conducted by the delivery system 10 of FIG. 1. Once products 12 reach delivery circuit 25, they are available for re-direction to purchaser 18. If seller 14 receives a product order at step (112), then at step (114), distributor 16 determines the closest delivery node 20a to 20e to the ordering purchaser 18. At step (116), a search of the sales product table 100 is conducted to determine whether there is a record for a product with the Destination Node field equal the node found in step (114) and for which the Sold field is “NO”. If at step (118), it is determined that there is no match then step (114) is repeated and the next closest node is determined. Step (116) is repeated as well.

This process is continued until at least one match is found. If at step (118) it is determined that there is more than one match, then at step (120) the product with the earliest Anticipated Arrival Time (AAT) is selected. If there is more than one such product, then the product with the oldest date of entry is selected. At step (122) the Final Destination Address field in the sales product record for the selected product is updated with the final address information and the Sold field is set equal to “YES”. At the same step the Default Destination Node field is cleared since this product has a final destination and there is no longer any need for the Default Destination Node. Then, at step (124) these changes are “pushed” down to the distribution product table 102.

At this point, it should be understood that the foregoing is based on the assumption that all products 12 having the same SKU and the same Seller ID are identical and interchangeable. As an example illustration of this process, assume that purchaser in this case is purchaser 18a that is located closest to delivery node 20b (Texas). Referring to FIG. 4A, as indicated by the sales product record associated with (i.e. UTN=54-234) in the sales product table 100, this product 12 is available to be sold and has a Destination Node of Texas (i.e. this product 12 is being transported around delivery circuit 25 from New York state (node 20a) to Texas (node 20b). Accordingly, delivery system 10 would target this product 12 for delivery to purchaser 18a.

Back at step (114), Texas (node 20b) would be identified as the next closest delivery node. Then at step (116), the sales product table 100 is searched. At step (118) it is determined that there is a match with product with UTN=54-234. Steps (120) and (122) are passed without any effect given that the identified product 12 is the only one found at step 116. At step (122), sales product table 100 of this identified product 12 is updated to remove the Default Destination Node (i.e. to leave it blank since it has an actual destination). The appropriate record in sales product table 100 is also updated to include the specific destination (i.e. home or business address of purchaser 18a) and to indicate that the product is sold (“YES”) as well as to include any special delivery instructions.

Further, the specific transportation means may have to be adjusted depending on the remaining delivery distance between the product 12 and purchaser 18a (i.e. from “train” to “plane”) and on the grade of delivery required by seller 14. Then at step (124) this information is pushed down to update the distribution product record within distribution product table 102. In this way, delivery system 10 achieves delivery of products 12 to purchaser 18 by separating the addressing (i.e. routing information) from product 12 such that the route and destination can be dynamically adjusted through suitable changes in the appropriate distribution product table 102 (i.e. indexed by UTN). When, at step (126), this product 12 reaches delivery node 20b, the UTN is read by a scanner or entered manually into a computer at delivery node 20b, and the delivery database queried for the destination information etc. and further processing and delivery of product 12 is achieved. After delivery, at step (128), the Delivered field is set to “YES” in order that the distribution product and sales product records for that UTN can be purged or archived.

Concurrently with the delivery, at step (130), the replenishment level is recalculated. This calculation consists of subtracting the outflow from the node from the inflow into the node. The inflow consists of any products 12 that have been delivered to this node or that are scheduled to be delivered to this node. The reason that the products 12 that are expected to arrive are also considered is to avoid problems similar to the “bullwhip effect” in which products that have been ordered but not yet arrived are ordered again, causing a build up of inventory once the orders are fulfilled.

The outflow has two components. The first are those products that have been delivered or are to be delivered to purchasers 18. Again, the reason that products that have not yet been delivered but are assigned to be delivered are considered is to avoid undercounting the outflow. The second component consists of those products 12 that have been rerouted to other nodes. If the result of the calculation is a deficit or alternatively if it is below a predefined threshold then at step (132) it is determined that there is a shortfall. If the result is non-negative or alternatively above a threshold then at step (132) it is determined that there is no shortfall. Should it be determined that there is a shortfall then at step (134) the next batch of products issued by the seller are assigned to be sent to this node. This is accomplished by either setting the Destination Node field of the sales product table 100 to the Present Node if there is a direct link from where the products enter the circuit 25 to the present node, or by setting the Default Destination Node field as the present node if there is no direct link.

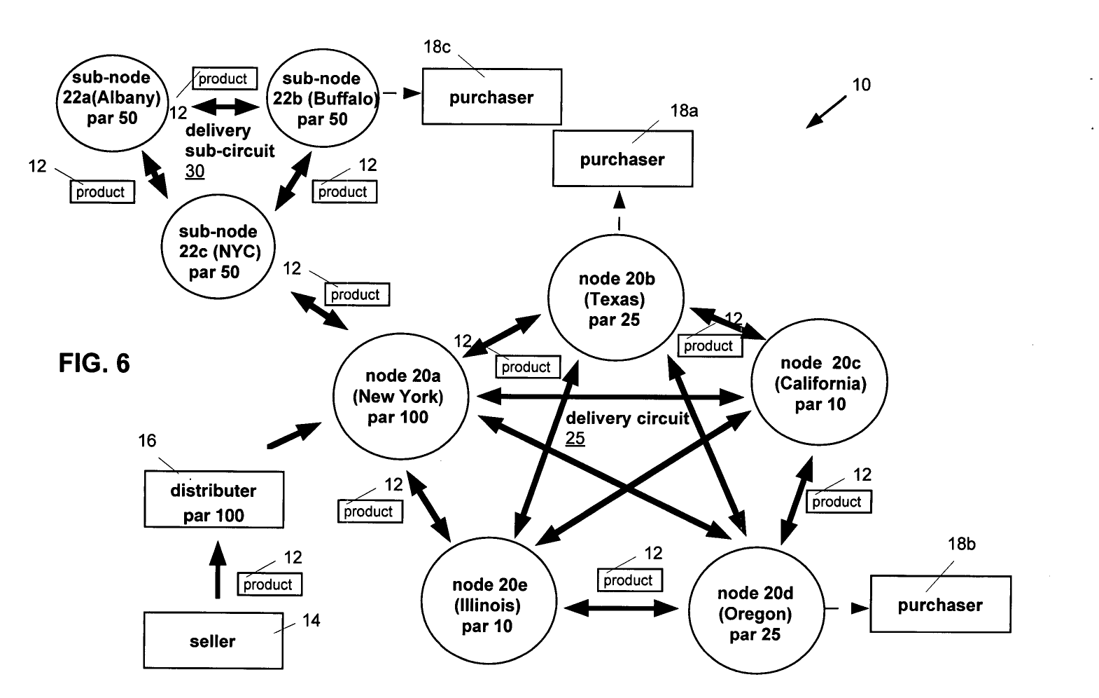

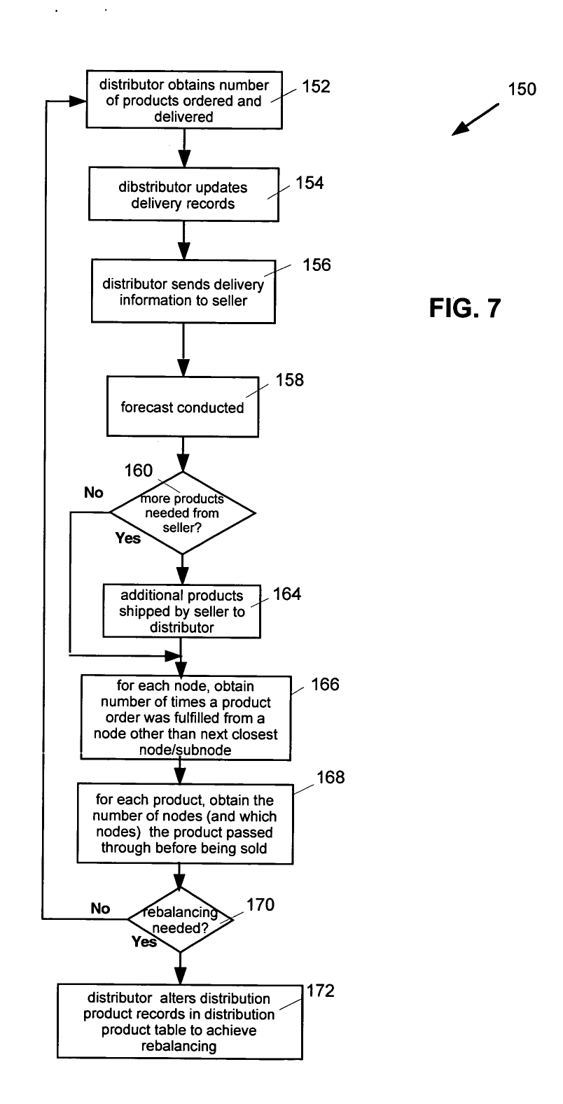

Referring now to FIGS. 6 and 7, the forecasting aspect of delivery system 10 will be further described. Specifically, FIG. 6 is a block diagram of delivery system 10 with product 12 flow quantities assigned to the various routes within delivery circuit 25 and delivery sub-circuit 30 as shown and FIG. 7 is a flowchart illustrating the process steps of the FLOW BALANCING routine conducted by the delivery system of FIG. 1.

As shown in FIG. 6, an example product flow of 100 units is shown traversing delivery circuit 25. It is contemplated that the overall time to deliver products 12 from seller 14 to delivery circuit 25 may be a substantial period of time (e.g. 7 to 10 days). Accordingly, it is important to ensure that a sufficient supply of product 12 within delivery circuit 25 is available in order to maintain rapid delivery of product 12 to purchasers 18 within delivery system 10. For illustrative purposes it will be assumed that product demand within delivery circuit 25 is 100 units per day (i.e. 50 units of product 12 in New York State (i.e. delivery sub-node 22b), 25 units of product 12 in Texas (i.e. delivery node 20b), and 25 units of product 12 in Oregon (i.e. delivery node 20e), as shown in FIG. 6. Also for illustrative purposes it is assumed that the products 12 are shipped around the perimeter of delivery circuit 25, although it should be understood that

Referring now to FIG. 7, at step (152) distributor 16 obtains on a daily basis the number of products ordered and delivered over the last delivery cycle (e.g. day). At step (154), distributor 16 updates delivery records in distribution product database 32 and at step (156) provides this information to seller 14 for dissemination and storage in sales product database 30. At step (158), forecasting is conducted in order to ensure that sufficient product 12 is provided to distributor 16 such that the volume of product 12 provided into delivery circuit 25 will be equal to the anticipated demand at the time that the additional product 12 is expected to enter delivery circuit 25 (e.g. within the 7 days it takes to ground ship the product 12). Product demand is forecasted (e.g. on a daily basis) by Stock Keeping Unit (SKU) or product type for particular target regions (e.g. delivery sub-circuit 30). While in some cases seller 14 may prefer to conduct forecasting in-house, it should be understood that either seller 14 or distributor 16 can conduct and manage the forecasting of product demand. It may be desirable to have distributor 16 provide a “turnkey” supply chain management solution to seller 14. In such a case, it would be distributor 16 who conducts the forecasting at step (158) and in that case, the distribution product record would contain additional fields from the sales product table 100 for example the SKU field.

Specifically, historical data and the like will help predict the percentage increase or decrease of product demand for different times of the year (e.g. holiday season) or as the popularity of a product 12 catches on etc. (e.g. using typical product adoption curves). For example, if a company in the United States knows, from studying its history of orders and demand, that it will sell ten units in New York in the next 6 days, the company can ship them to New York (i.e. delivery node 20a) without the associated final address destination. Shipping can be initiated knowing that it will take two days before the unit reaches the next delivery node 20b where it would then be dispatched to purchasers 18 in Texas. The associated distribution product table 102 will be populated with addressing information that is updated or partially populated once or more than once while product 12 is in transit.

Generally, in order to provide acceptable delivery time of product 12 to purchaser 18, it is necessary to properly estimate product demand within delivery circuit 25 and to dynamically “re-balance” the product flow of products 12 within delivery circuit 25 as products 12 are being delivered to and from delivery circuit 25. At step (166), information at each node is gathered regarding the number of times a product order at that node was fulfilled from a node other than the next closest node or sub-node. Similarly, at step (168) for each of the products, information is obtained regarding how many nodes, and in particular, which nodes the product passed through before being sold. Then at step (170), it is determined whether “rebalancing” of the product flow within delivery circuit 25 is required based on the information gathered in steps (168) and (170).

For example, if, at a particular node, the number of orders fulfilled from nodes other than the next closest node or sub-node is too great then this is an indication that more products should be initially directed there. In particular, of the new products issued by the seller, a number of products corresponding to the amount observed in steps (168) and (170) should instead of being sent to the nodes from which surplus products have been redirected, should be initially directed to the nodes with shortages. In other words, at step (172) the par value of the nodes with shortages will be increased while those from which surplus products are redirected will have their par values decreased.

Similarly, should there be a particular product type that consistently passes through too great a number of nodes before being sold then this is an indication that there are too many of these products in the system. To a lesser extent it could also indicate that the products are initially sent to nodes at which there is too little a demand for the products. Thus, at step (172) the par values for all the nodes would be lowered accordingly.

In addition, rebalancing is required where there is a large number of products 12 being transported together along delivery circuit 25 (i.e. in a “cluster”) and fewer products 12 are being transported along other routes along delivery circuit 25. In such a case, if product 12 is ordered by a purchaser 18 that is distant from the product cluster, then it can take longer to route sufficient product 12 to purchaser 18 then would be the case if there was no such cluster. If rebalancing is required, then at step (168), “rebalancing” is accomplished by dynamically adjusting (i.e. refining) the “destination” field of appropriate distribution product table 102 as products 12 traverses through delivery circuit 25. For example, it is contemplated that if such a product cluster forms within delivery circuit 25, it would be possible to re-route products 12 either to route them at a slower rate or to be routed “backwards” to reduce the volume of the product cluster. These decisions will be made by distributor 16 and carried out when product 12 reaches delivery nodes 20a to 20e or delivery sub-nodes 22a to 22c and will depend on the practical tradeoffs between storage and transportation resources.

Accordingly, delivery system 10 utilizes rebalancing to redirect or flow excess products 12 in one part of the delivery circuit 25 to areas where there are less products 12 available than anticipated sales volumes indicate. As previously discussed, it is an overriding concern to keep the flow of product 12 within delivery circuit 25 as close to the “ideal” par flow levels that are originally forecast by seller 14 (e.g. five units per day at sub-node 22a, 10 units at sub-node 22 etc.) The goal of the rebalancing conducted within delivery system 10 is to maintain a consistent product flow through the circuit such that the majority of the products being sent to a particular delivery node are sold while in transit but prior to arriving at that delivery node. The redirecting or flow of product around the circuit will keep unsold product moving preferably to a destination node where it has a high probability to be sold. When rebalancing is properly working within delivery system 10 there will only be a “trickle” of product traveling from one major node to another major node in order to maintain balance within the system.

Accordingly, delivery system 10 provides timely delivery of product 12 to purchaser 18 by shipping product 12 to a delivery circuit 25 for transportation within the delivery circuit 25 in advance of the purchaser's order, such that the ordered product 12 is available for delivery to purchaser 18 from a reasonably close delivery node within delivery circuit 25. By in effect, pre-shipping product 12 for transportation within delivery circuit 25, in advance of the customer order the delivery time to purchaser is reduced by the time it takes to initially transport product 12 from seller 14 to delivery circuit 25 (which can be a lengthy time period of 7 to 10 days). That is, major haul distances can be traversed prior to a purchase order utilizing cost effective modes of transport. From purchaser's 18 point of view, product 12 appears to have been delivered rapidly possibly using high cost transportation (e.g. air delivery). In fact, it is possible to utilize very low cost transportation for product 12 from seller to delivery circuit 25 (i.e. ocean shipping) and then within delivery circuit 25 (e.g. train). Also, by using a Unit Tracking Number (UTN) that is affixed by OEM as the key field for all related parts of the distribution chain can save costs as the package will require less handling (i.e. If a package already has a UTN number affixed by the OEM, the seller would not need to affix any additional labels to the product 12. Finally, delivery system 10 ensures that sufficient product is provided to delivery circuit 25 based on estimated/forecasted demand. Delivery system 10 conducts periodic rebalancing of the product flow for effective delivery of product 12 to purchasers from within delivery circuit 25.

As will be apparent to those skilled in the art, various modifications and adaptations of the structure described above are possible without departing from the present invention, the scope of which is defined in the appended claims.

1. A method of delivering one of a plurality of identical products associated with a seller to a purchaser, said method comprising:
(a) transporting the identical products in a delivery circuit that includes a plurality of delivery nodes by transporting the identical products between delivery nodes at a first speed;
(b) determining if one of said identical products has been ordered by one of the purchasers;
(c) if (b) is true then determining which of said plurality of delivery nodes is closest to said purchaser;
(d) providing the closest one of said identical products to the delivery node identified in (c) along the delivery circuit and then transporting said closest one of said identical products from the delivery node identified in (c) to said purchaser.

2. The method of claim 1, wherein (a) further comprises associating each of said identical products with a unique tracking number and wherein (d) further comprises determining the destination address of said purchaser and pushing said unique tracking number and destination address to the delivery node identified in (c) prior to the physical arrival of the one of said identical products at the delivery node identified in (c).

3. The method of claim 1, wherein (a) further comprises associating each of said identical products with a destination node and wherein step (c) further comprises recording said delivery node identified in (c) as the destination node for said closest one of said identical products.

4. The method of claim 1, wherein (a) further comprises associating each of said identical products with a destination node and a default destination node, wherein said destination node is the closest delivery node to the current position of the product and the default destination node is a delivery node adjacent to the destination node.

5. The method of claim 4, wherein when the product reaches the destination node, (a) further comprises changing the destination node so that it corresponds to the previous default destination node and to change the default destination node by choosing from the set of delivery nodes adjacent to the destination node.

6. The method of claim 1, wherein (d) further comprises transporting the closest one of said identical products through a series of delivery nodes to the delivery node identified in (c).

7. The method of claim 1, wherein (d) further comprises storing the closest one of said identical products at the delivery node identified in (c).

8. The method of claim 1, wherein the transportation of the product from said identified delivery node to the purchaser is conducted at a second speed wherein said first speed is less than said second speed.

9. The method of claim 1, wherein the products are transported within a sub-set of said delivery nodes to service a particular section of said delivery circuit.

10. The method of claim 1, further comprising the delivery of the products from the seller to the delivery circuit.

11. The method of claim 10, further comprising:
(i) estimating demand for the products at each delivery node associated with said delivery circuit;
(ii) providing a sufficient quantity of the products from the seller to said delivery circuit for prospective delivery.

12. The method of claim 1, further comprising:
(I) determining whether there is a cluster of products within said delivery circuit;
(II) if (I) is true, then rebalancing the flow of said products within said delivery circuit by re-directing at least some of said products.

13. A delivery system for delivering a plurality of identical products associated with a seller to a plurality of purchasers, said system comprising:
(a) a first delivery module for transporting the identical products in a delivery circuit that includes a plurality of delivery nodes at a first speed;
(b) a distribution module associated with said first delivery module for determining if one of the products has been ordered by said one of the purchasers, and if so then determining which of said plurality of delivery nodes is closest to said one of the purchasers; and
(c) a second delivery module associated with said distribution module for providing the closest of said identical products to said identified delivery node through said delivery circuit and then from said identified delivery node to said one of the purchasers.

14. The system of claim 13, wherein said first delivery module is further adapted to associate each of said identical products with a unique tracking number and wherein said second delivery module is further adapted to determine the destination address of said purchaser and to push said unique tracking number and destination address to the identified delivery node prior to the physical arrival of the one of said identical products at the identified delivery node.

15. The system of claim 13, wherein said first delivery module is further adapted to associate each of said identical products with a unique tracking number and a destination node and wherein said second delivery module is further adapted to record said identified delivery node as the destination node for said closest one of said identical products.

16. The system of claim 13, wherein said first delivery module is further adapted to associate each of said identical products with a destination node and a default destination node, wherein said destination node is the closest delivery node to the current position of the product and the default destination node is a delivery node adjacent to the destination node.

17. The system of claim 13, wherein when the product reaches the destination node, the first delivery module is further adapted to change the destination node so that it corresponds to the previous default destination node and to change the default destination node by choosing from the set of delivery nodes adjacent to the destination node.

18. The system of claim 13, wherein said second delivery module is further adapted to transport the closest one of said identical products through a series of delivery nodes to the identified delivery node.

19. The system of claim 13, wherein said second delivery module is further adapted to store the closest one of said identical products at the identified delivery node.

20. The system of claim 13, wherein said second delivery module is further adapted to transport the product from said identified delivery node to the purchaser at a second speed wherein said first speed is less than said second speed.

21. The system of claim 13, wherein said first delivery module transports the products within a sub-set of said delivery nodes to service a particular section of said delivery circuit.

22. The system of claim 13, wherein said distribution module is further adapted to:
(i) estimate demand for the products at each delivery node associated with said delivery circuit;
(ii) provide a sufficient quantity of the products from the seller to said delivery circuit for prospective delivery.

23. The system of claim 13, wherein said distribution module is further adapted to:
(I) determine whether there is a cluster of products within said delivery circuit;
(ii) if (I) is true, then rebalancing the flow of said products within said delivery circuit by re-directing at least some of said products.
